(19) United States
(12) Patent Application Publication
(10) Pub. No.: US 2016/0204628 A1
(43) Pub. Date: Jul. 14, 2016

(54) POWER BANK APPARATUS FOR MEASURING CAPACITIES OF OTHER POWER BANKS

(71) Applicant: Digipower Manufacturing Inc., New Taipei City (TW)

(72) Inventor: Min-Huang Huang, New Taipei City (TW)

(21) Appl. No.: 14/676,760

(22) Filed: Apr. 1, 2015

(30) Foreign Application Priority Data
Jan. 14, 2015 (TW) 104200580

(51) Int. Cl. H02J 7/00; G06F 1/26

(52) U.S. Cl. CPC H02J 7/0021; H02J 7/0047; H02J 7/007; H02J 7/0054; G06F 1/26; H02J 2007/005; H02J 2007/0096

(57) ABSTRACT

A power bank apparatus for measuring capacities of other power banks is provided. The power bank apparatus includes at least one input port, at least one detection circuit, and a processing circuit. The input port is configured to receive an input power signal from the other power bank as a capacity measuring signal. The detection circuit is connected to the input port to receive the capacity measuring signal. The detection circuit detects a voltage and a current of the capacity measuring signal to generate a voltage value and a current value. The processing circuit is connected to the detection circuit to receive the voltage value and the current value. The processing circuit calculates a power supply time according to the current value. The processing circuit calculates a capacity value of the other power bank according to the voltage value, the current value, and the power supply time.

### CROSS-REFERENCE TO RELATED APPLICATION

This application claims the priority benefit of Taiwan application serial no. 104200580, filed on Jan. 14, 2015. The entirety of the above-mentioned patent application is hereby incorporated by reference herein and made a part of this specification.

### TECHNICAL FIELD

The invention relates to a power bank, and more particularly to a power bank apparatus for measuring capacities of other power banks.

### RELATED ART

With the rapid development of the mobile device, typically the mobile device is able to support features such as a high resolution display, photography, video playback, or wireless internet. However, these functions often quickly consume the battery power in the mobile device. Therefore, the user typically needs an extra power bank to charge the mobile device to prevent the mobile device from exhausting the power.

The commercial power banks available nowadays have a power (or capacity) represented in watt-hour (Wh) or ampere-hour (Ah). When the power bank is new, the full capacity may be equal to a labeled capacity (or rated capacity) when the power bank is shipped, and the labeled capacity is typically labeled on the housing of the power bank or on an instruction manual. However, the user generally cannot verify whether the full capacity when the power bank is new matches the labeled capacity, and accordingly the user is unable to prove whether the capacity labeled by the manufacturer is an exaggeration. Moreover, after the power bank has been used for a period of time, the batteries in the power bank gradually ages due to repeated use. At this time, the full capacity of the power bank becomes lower than the labeled capacity when the power bank is shipped. The user generally does not know the full capacity value of the power bank, however. If the user knows the full capacity value of the power bank, then the user can accordingly determine whether to replace this power bank. Furthermore, only one light emitting diode (LED) is typically configured in the power bank, and the leftover capacity is represented by whether the LED emits light or the different colors of light emitted by the LED. In other words, the user generally cannot accurately determine the current leftover capacity value of the power bank, which results in user inconvenience.

### SUMMARY OF THE INVENTION

The invention provides a power bank apparatus using battery charge management and calculations of the energy accumulated by the input power voltage and current to measure the capacities of other power banks, such that a full capacity value or a leftover capacity of the other power banks are measured.

The invention provides a power bank apparatus configured to measure a capacity value of at least one other power bank. The power bank apparatus includes at least one input port, at least one first detection circuit, and a processing circuit. The at least one input port is configured to receive at least one input power signal from the at least one other power bank to serve as at least one capacity measuring signal. The at least one first detection circuit is connected to the at least one input port to receive the at least one capacity measuring signal. The at least one first detection circuit detects a voltage and a current of the at least one capacity measuring signal to generate at least one first voltage value and at least one first current value. The processing circuit is connected to the at least one first detection circuit to receive the at least one first voltage value and the at least one first current value. The processing circuit calculates at least one power supply time according to the at least one first current value. The processing circuit calculates the capacity value of the at least one other power bank according to the at least one first voltage value, the at least one first current value, and the at least one power supply time.

In one embodiment of the invention, the power bank apparatus further includes a Universal Serial Bus (USB) output port connected to the processing circuit and another mobile device. The capacity value calculated by the processing circuit is transmitted to the other mobile device through the USB output port, in order for the other mobile device to display the capacity value.

In one embodiment of the invention, the power bank apparatus further includes a charge control unit connected to the at least one input port to receive the at least one capacity measuring signal. The charge control unit is controlled by the processing circuit to convert the capacity measuring signal and generate a charge signal.

In one embodiment of the invention, the power bank apparatus further includes a battery connected to the charge control unit and receiving the charge signal, so as to be charged. The battery serves as a load of the at least one other power bank.

In one embodiment of the invention, the power bank apparatus further includes a discharge control unit connected to the battery. The discharge control unit is controlled by the processing circuit to convert a voltage of the battery and thereby generate at least one discharge signal.

In one embodiment of the invention, the power bank apparatus further includes at least one output port connected to the discharge control unit and receiving the at least one discharge signal to serve as at least one output power signal. The at least one output port provides the at least one output power signal to at least one external load.

In one embodiment of the invention, in the power bank apparatus, the at least one external load is at least one mobile device.

In one embodiment of the invention, in the power bank apparatus, the at least one external load is the at least one other power bank, in which the power bank apparatus further includes at least one second detection circuit. The at least one second detection circuit is connected to the discharge control unit to receive the at least one discharge signal. The at least one second detection circuit measures a voltage and a current of the at least one discharge signal and generates at least one second voltage value and at least one second current value. The processing circuit determines whether the at least one other power bank has completed charging according to the at least one second current value. When a determination result is yes, the processing circuit controls the discharge control unit to stop generating the at least one discharge signal. The processing circuit controls the charge control unit to begin generating the charge signal, and the processing circuit begins to calculate the at least one power supply time according to the at least one first current value.

In one embodiment of the invention, in the power bank apparatus, the at least one output port is connected to the processing circuit. The processing circuit outputs the capacity value of the at least one other power bank to a mobile device through the at least one output port. The mobile device includes a mobile application program configured to display the capacity value of the at least one other power bank.

In one embodiment of the invention, the power bank apparatus further includes a capacity display connected to the processing circuit. The capacity display is configured to display the capacity value of the at least one other power bank.

In summary, the power bank apparatus in embodiments of the invention may measure the capacities of other power banks. The first detection circuit may detect the voltage and current from the other power bank to serve as the first voltage value and the first current value. The processing circuit may calculate the power supply time of the other power bank providing the input power signals. The processing circuit may calculate the capacity of the other power bank according to the first voltage value, the first current value, and the power supply time. Moreover, the power bank apparatus in embodiments of the invention may measure the capacity of the other power bank after charging the other power bank. As such, the full capacity or the leftover capacity of the other power bank may be determined. In addition, the measured capacity value of the other power bank can be outputted to the mobile device, and a mobile application program of the mobile device can be used to display the capacity value. Alternatively, the capacity value may be displayed on the capacity display of the power bank apparatus. Accordingly, the user can clearly determine the measured capacity of the other power bank. Besides, the power bank apparatus in embodiments of the invention may also be used to measure the full capacity of the other power bank when it is new, in order to verify whether the full capacity of the other power bank matches with the labeled capacity.

To make the above features and advantages of the present invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram of a power bank apparatus for measuring capacities of other power banks according to an embodiment of the invention.

FIG. 2A and FIG. 2B are schematic diagrams of a method of the power bank apparatus of FIG. 1 measuring a capacity of another power bank.

FIG. 3A and FIG. 3B are schematic diagrams of another method of the power bank apparatus of FIG. 1 measuring the capacity of the other power bank.

FIG. 4 is a schematic diagram of another method the power bank apparatus of FIG. 1 measuring the capacity of the other power bank.

### DETAILED DESCRIPTION OF DISCLOSED EMBODIMENTS

In the following, descriptions of the invention are given with reference to the exemplary embodiments illustrated with accompanied drawings. Moreover, elements/components/notations with same reference numerals represent same or similar parts in the drawings and embodiments.

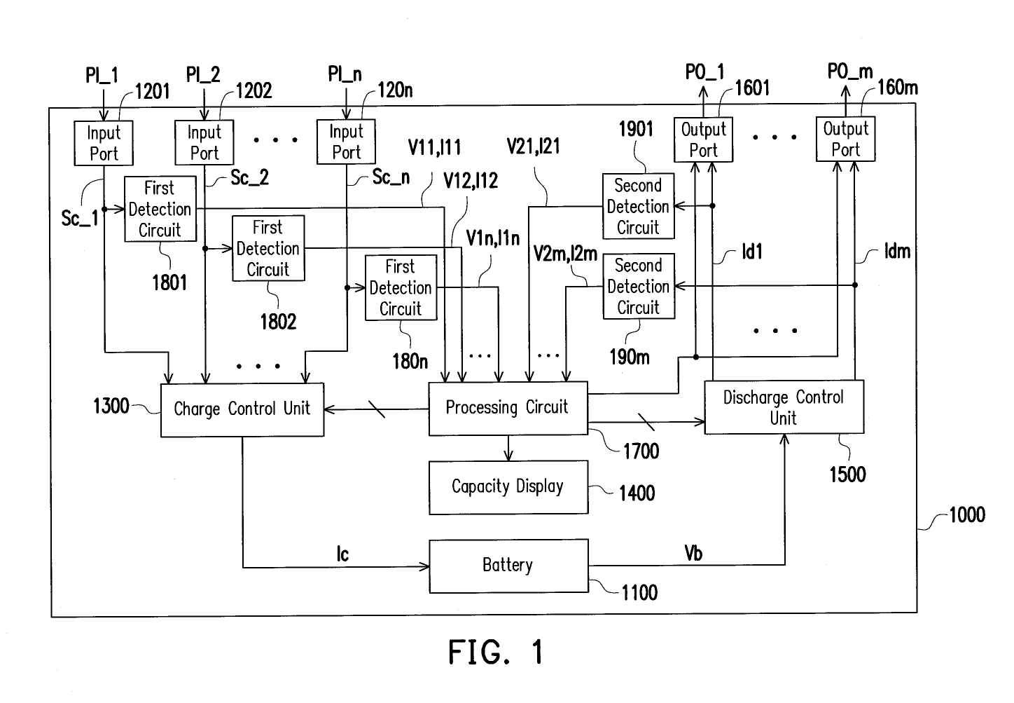

With reference to FIG. 1, FIG. 1 is a schematic block diagram of a power bank apparatus 1000 for measuring capacities of other power banks according to an embodiment of the invention. The power bank apparatus 1000 may include a battery 1100, at least one input port 1201-120n, a charge control unit 1300, a discharge control unit 1500, at least one output port 1601-160m, a processing circuit 1700, at least one first detection circuit 1801-180n, and at least one second detection circuit 1901-190m.

The input ports 1201-120n are configured to receive at least one input power signal PI_1-PI_n from at least one other power bank (not drawn) to serve as at least one capacity measuring signal Sc_1-Sc_n. In one embodiment of the invention, the input ports 1201-120n may be Universal Serial Bus (USB) input ports, although the invention is not limited thereto. In the aforementioned embodiment, the input ports 1201-120n may be different types of USB input ports, such as micro-USB input ports, mini-USB input ports, or USB 3.1 Type-C input ports, for example.

The first detection circuits 1801-180n are connected to the input ports 1201-120n to receive the capacity measuring signals Sc_1-Sc_n. The first detection circuits 1801-180n detect a voltage and a current of the capacity measuring signal Sc_1-Sc_n to generate at least one first voltage value V11-V1n and at least one first current value I11-I1n. In one embodiment of the invention, each of the first detection circuits (e.g. first detection circuit 1801) may include a voltage detection circuit (not drawn) and a current measuring circuit (not drawn), although the invention is not limited thereto. The voltage detection circuit in each of the first detection circuits (e.g. first detection circuit 1801) may detect a voltage value of a capacity measuring signal (e.g. capacity measuring signal Sc_1) to serve as a first voltage value (e.g. first voltage value V11). The current measuring circuit in each of the first detection circuits (e.g. first detection circuit 1801) may detect a current value of a capacity measuring signal (e.g. capacity measuring signal Sc_1) to serve as a first current value (e.g. first current value I11).

The processing circuit 1700 is connected to the first detection circuits 1801-180n to receive the first voltage values V11-V1n and the first current values I11-I1n. The processing circuit 1700 calculates at least one power supply time according to the first current values I11-I1n, and the processing circuit 1700 calculates a capacity value of the at least one other power bank according to the first voltage values V11-V1n, the first current values I11-I1n, and at least one power supply time.

The charge control unit 1300 is connected to the input ports 1201-120n to receive the capacity measuring signals Sc_-Sc_n. The charge control unit 1300 is controlled by the processing circuit 1700 to convert the capacity measuring signals Sc_1-Sc_n and thereby generate a charge signal Ic. The charge control unit 1300 is connected to the battery 1100, and the charge control unit 1300 charges the battery 1100 according to the charge signal Ic. In one embodiment of the invention, the charge control unit 1300 may include a plurality of direct current (DC) boost circuits (not drawn) and a voltage-to-current conversion circuit (not drawn), although the invention is not limited thereto. The DC boost circuits in the charge control unit 1300 may respectively perform a boost process on the capacity measuring signals Sc_1-Sc_n to generate a first boost signal. The voltage-to-current conversion circuit in the charge control unit 1300 performs a voltage-to-current conversion on the first boost signal to generate the charge signal Ic. The charge control unit 1300 outputs the charge signal Ic to the battery 1100 to charge the battery 1100.

The battery 1100 may represent a single battery (or battery element), a battery pack, or a module including one or a plurality of batteries (or battery element). Besides, the battery 1100 may be chargeable batteries such as a NiZn battery, a NiMH battery, or a lithium battery, although the invention is not limited thereto.

The discharge control unit 1500 is connected to the battery 1100. The discharge control unit 1500 is controlled by the processing circuit 1700 to convert a voltage Vb of the battery 1100 and thereby generate at least one discharge signal Id1-Idm. In one embodiment of the invention, the discharge control circuit 1500 may include a DC boost circuit (not drawn) and a voltage-to-current conversion circuit (not drawn), although the invention is not limited thereto. The DC boost circuit in the discharge control unit 1500 may perform a boost process on the voltage Vb of the battery 1100 to generate a second boost signal. The voltage-to-current conversion circuit in the discharge control unit 1500 performs a voltage-to-current conversion on the second boost signal to generate the at least one discharge signals Id1-Idm.

The output ports 1601-160m are connected to the discharge control unit 1500. The output ports 1601-160m receive the discharge signals Id1-Idm to serve as the output power signals PO_1-PO_m. The output ports 1601-160m provide the output power signals PO_1-PO_m to at least one load (not drawn) to provide power to the at least one load. In one embodiment of the invention, the at least one load may be a mobile device, such as a mobile phone, a tablet computer, or a power bank, although the invention is not limited thereto. In one embodiment of the invention, the output ports 1601-160m may be USB output ports, although the invention is not limited thereto. In embodiments of the invention, the output ports 1601-160m may be different types of USB output ports.

The second detection circuits 1901-190m are connected to the discharge control unit 1500 to receive the discharge signals Id1-Idm. The second detection circuits 1901-190m measure a voltage and a current of the discharge signals Id1-Idm to generate the second voltage values V21-V2m and the second current values I21-I2m. The processing circuit 1700 may determine whether the at least one other power bank has completed charging according to the second current values I21-I2m.

In one embodiment of the invention, each of the second detection circuits (e.g. second detection circuit 1901) may include a voltage detection circuit (not drawn) and a current measuring circuit (not drawn), although the invention is not limited thereto. The voltage detection circuit in each of the second detection circuits (e.g. second detection circuit 1901) may detect a voltage value of a discharge signal (e.g. discharge signal Id1) to serve as a second voltage value (e.g. second voltage value V21). The current measuring circuit in each of the second detection circuits (e.g. second detection circuit 1901) may detect a current value of a discharge signal (e.g. discharge signal Id1) to serve as a second current value (e.g. second current value I21).

When the power bank apparatus 1000 provides an output power signal (e.g. output power signal PO_1) to one of the other power banks through an output port (e.g. output port 1601), a current value of a discharge signal (e.g. discharge signal Id1) gradually decreases as the capacity of this one of the other power banks increases. Therefore, the processing circuit 1700 may determine whether this one of the other power banks has completed charging (i.e. referred as fully charged) according to a second current value (e.g. second current value I21). For example, when the processing circuit 1700 detects that the second current value (e.g. second current value I21) is smaller than a preset charge termination current (e.g. 0.02 A, although not limited thereto), the processing circuit 1700 may determine that this one of the other power banks has completed charging. Alternatively, when this other power bank has completed charging, a charge path inside this other power bank may be cut off to prevent overcharge of the internal battery. Accordingly, this other power bank no longer receives the output power signal (e.g. output power signal PO_1) provided by the power bank apparatus 1000. Therefore, the current value of the discharge signal (e.g. discharge signal Id1) is reduced to 0 A, such that the processing circuit 1700 detects the second current value (e.g. second current value I21) as 0 A. At this time, the processing circuit 1700 may determine that this other power bank has completed charging.

In embodiments of the invention, the processing circuit 1700 may be implemented by a micro-processor, a digital signal processor (DSP), an application-specific integrated circuit (ASIC), or a field-programmable gate array (FPGA). Moreover, the charge control unit 1300, the discharge control unit 1500, the first detection circuits 1801-180n, and the second detection circuits 1901-190n may be implemented by an ASIC or a FPGA. The charge control unit 1300, the discharge control unit 1500, the first detection circuits 1801-180n, and the second detection circuits 1901-190n may be implemented by separate circuit chips, or they may be partially or fully integrated by a single integrated circuit chip, although the invention is not limited thereto.

The disclosure hereafter further describes the operation of the power bank apparatus 1000 in detail. To facilitate description, the embodiments hereafter adopt an illustrative example of the power bank apparatus 1000 measuring the capacity of one other power bank. The implementation of the power bank apparatus 1000 simultaneously measuring the capacities of a plurality of other power banks may be similarly deduced from the description hereafter.

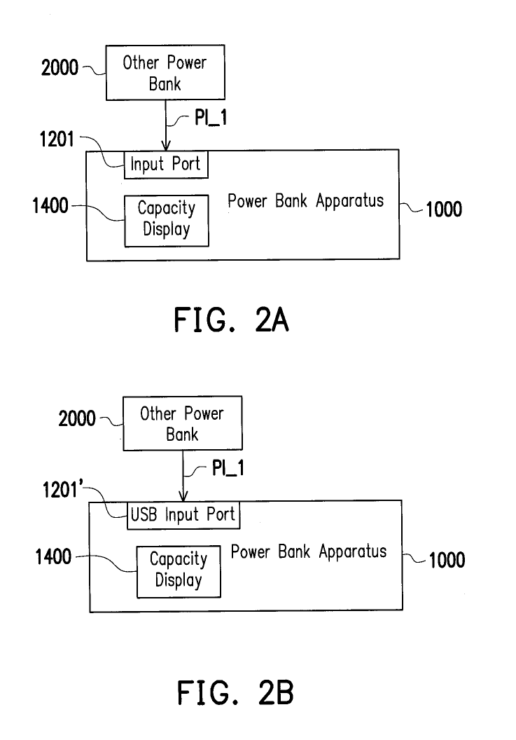

With reference to FIG. 1 and FIG. 2A, FIG. 2A is a schematic diagram of a method of the power bank apparatus 1000 of FIG. 1 measuring a capacity of another power bank 2000. As shown in FIG. 2A, the other power bank 2000 is connected to the input port 1201. The input port 1201 may receive the input power signal PI_1 from the other power bank 2000 to serve as the capacity measuring signal Sc_1. Assume here that the input power signal PI_1 is 5 V and 2 A (i.e. power of 10 W. When the processing circuit 1700 controls the charge control unit 1300 to perform the boost process and the voltage-to-current conversion process on the capacity measuring signal Sc_1, the first detection circuit 1801 may detect the voltage and the current of the capacity measuring signal Sc_1 and generate the first voltage value of 5 V and the first current value I11 of 2 A. The processing circuit 1700 may also begin counting a power supply time t.

As the other power bank 2000 continues to supply power to the power bank apparatus 1000, the capacity of the other power bank 2000 gradually decreases, until the capacity of the other power bank 2000 is fully depleted and supplied (i.e. no leftover power) and turned off, in which the other power bank 2000 no longer provides the capacity measuring signal Sc_1 to the power bank apparatus 1000. Therefore, the first current value I11 of the capacity measuring signal Sc_1 detected by the first detection circuit 1801 is 0 A, and at this time, the processing circuit 1700 stops counting the power supply time t.

In other words, the processing circuit 1700 may calculate the power supply time t according to the first current value I11 detected by the first detection circuit 1801. That is, the power supply time t may be a time period in which the first current value I11 is not 0. Thereafter, the processing circuit 1700 may calculate a capacity value of the other power bank 2000 according to the first voltage value V11 (5 V), the first current value I11 (2 A), and the power supply time t. For example, when the power supply time t counted by the processing circuit 1700 is 2 hours, then the capacity value of the other power bank 2000 under an output voltage of 5 V is 4 Ah (i.e., a product of the first current value I11 and the power supply time t). Alternatively, the capacity value of the other power bank 2000 is 20 Wh (i.e., a product of the first voltage value V11, the first current value I11, and the power supply time t).

In embodiments of the invention, if the power bank apparatus 1000 performs the capacity measurement when the capacity of the other power bank 2000 is full, then the capacity value of the other power bank 2000 measured by the power bank apparatus 1000 is the full capacity value of the other power bank 2000. Otherwise, the capacity value of the other power bank 2000 measured by the power bank apparatus 1000 is the leftover capacity value of the other power bank 2000.

On the whole, when the first current value I11 of the capacity measuring signal Sc_1 received by the processing circuit 1700 is not 0 A, the processing circuit 1700 may control the charge control unit 1300 to convert the capacity measuring signal Sc_1 and generate the charge signal Ic. The charge control unit 1300 outputs the charge signal Ic to the battery 1100 to charge the batter 1100. Accordingly, while measuring the capacity of the other power bank 2000, the battery 1100 may be used as a load of the other power bank 2000.

Typically speaking, while measuring the capacity of a power bank, the power bank needs to be charged and then discharged, which results in the waste of electricity. On the other hand, while the power bank apparatus 1000 in embodiments of the invention measures the capacity of the other power bank 2000, the capacity of the other power bank 2000 may be stored in the battery 1100 of the power bank apparatus 1000, so as to prevent the waste of electricity.

In one embodiment of the invention, the input port 1201 of FIG. 2A may be implemented by different types of USB input ports, such as a USB input 1201′ shown in FIG. 2B.

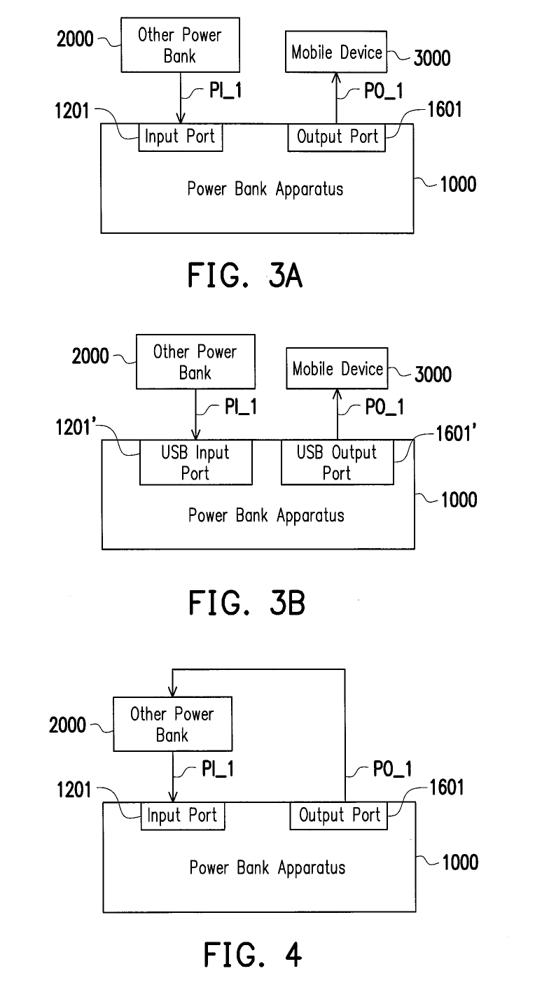

In one embodiment of the invention, at least one mobile device may serve as at least one load of at least one other power bank. With reference to FIG. 1 and FIG. 3A, FIG. 3A is a schematic diagram of another method of the power bank apparatus 1000 of FIG. 1 measuring the capacity of the other power bank 2000. Compared to the measurement method depicted in FIG. 2A, the measurement method of FIG. 3A connects a mobile device 3000 to the output port 1601 to serve as a load of the other power bank 2000. Accordingly, the discharge control unit 1500 may be controlled by the processing circuit 1700 to convert the voltage Vb of the battery 1100 and thereby generate the discharge signal Id1. The output port 1601 may receive the discharge signal Id1 to serve as the output power signal PO_1, and provide the output power signal PO_1 to the mobile device 3000 to charge the mobile device 3000. As a result, the power bank apparatus 1000 is prevented from terminating the capacity measurement of the other power bank 2000 due to the battery 1100 being fully charged. The mobile device 3000 may be a mobile phone, a tablet computer, a power bank, or a portable gaming device, for example, although the invention is not limited thereto. An embodiment having two or more mobile devices serving as the loads of the other power bank 2000 may be deduced from the foregoing description, and therefore further elaboration thereof is omitted.

In one embodiment of the invention, the input port 1201 of FIG. 3A may be implemented by different types of USB input ports, and the output port 1601 of FIG. 3A may be implemented by different types of USB output ports, such as a USB input port 1201′ and a USB output port 1601′ shown in FIG. 3B.

In one embodiment of the invention, the power bank apparatus 1000 may first charge the other power bank 2000, and once the charging of the other power bank 2000 is complete, the capacity of the other power bank 2000 may be measured. Accordingly, the capacity value of the other power bank 2000 measured by the power bank apparatus 1000 represents a full capacity of the other power bank 2000.

With reference to FIG. 1 and FIG. 4, FIG. 4 is a schematic diagram of another method the power bank apparatus 1000 of FIG. 1 measuring the capacity of the other power bank 2000. Compared to the measurement method depicted in FIG. 2A, the measurement method of FIG. 4 connects the other power bank 2000 to the input port 1201 and the output port 1601 of the power bank apparatus 1000. Accordingly, the discharge control unit 1500 may be controlled by the processing circuit 1700 to convert the voltage Vb of the battery 1100 and thereby generate the discharge signal Id1. The output port 1601 may receive the discharge signal Id1 to serve as the output power signal PO_1, and provide the output power signal PO_1 to the other power bank 2000 to charge the other power bank 2000. The second detection circuit 1901 may receive the discharge signal Id1, and measure the voltage and the current of the discharge signal Id1 to generate the voltage value (e.g. second voltage value V21) and current value (e.g. second current value I21) of the discharge signal Id1.

The second current value I21 gradually decreases as the capacity of the other power bank 2000 rises. The processing circuit 1700 may determine whether the other power bank 2000 has completed charging according to the second current value I21. That is, whether the capacity of the other power bank 2000 is full at this time is determined. The implementation of the processing circuit 1700 determining whether the other power bank 2000 has completed charging according to the second current value I21 may be referenced to the description related to FIG. 1, and further elaboration thereof is omitted hereafter. Accordingly, the processing circuit may control the discharge control circuit 1500 to stop generating the discharge signal Id1 in order to terminate the charging operation on the other power bank 2000. Thereafter, the processing circuit 1700 may control the charge control unit 1300 to convert the received capacity measuring signal Sc_1 to generate the charge signal Ic, so as to begin the discharge operation on the other power bank 2000. At this time, the processing circuit 1700 may begin calculating the power supply time according to the first current value I11, so as to measure the capacity of the other power bank 2000. The operation of the power bank apparatus 1000 measuring the capacity of the other power bank 2000 may be referenced to the description related to FIG. 1 and FIG. 2A, and therefore further elaboration thereof is omitted hereafter.

With reference to FIG. 1 and FIG. 3A, the output ports 1601-160m are connected to the processing circuit 1700. The processing circuit 1700 may output the capacity value of the other power bank 2000 to the mobile device 3000 (e.g. smart phone or tablet computer, although not limited thereto) through the output port 1601. For example, when the mobile device 3000 is connected to the output port 1601, the processing circuit 1700 may output the measured capacity value of the other power bank 2000 to the mobile device 3000 through the output port 1601. The mobile device has a special purpose mobile application program. The capacity value of the other power bank 2000 can be displayed after executing this mobile application program. It should be noted that, the user interface rendered by the mobile application program for displaying the capacity value of the other power bank 2000 may be adjusted according to an actual design or application requirement. Besides displaying the capacity value of the other power bank 2000, the user interface may also independently display other parameters of the power bank 2000, such as output power, output current, output power, and estimated power supply time, although not limited thereto.

With reference to FIG. 1 and FIG. 2A, in one embodiment of the invention, the power bank apparatus 1000 further includes a capacity display 1400 connected to the processing circuit 1700. The processing circuit 1700 may display the capacity value of the other power bank 2000 on the capacity display 1400.

In view of the foregoing, the power bank apparatus in embodiments of the invention may measure the capacities of other power banks. The first detection circuit may detect the voltage and current from the other power bank to serve as the first voltage value and the first current value. The processing circuit may calculate the power supply time of the other power bank providing the input power signals. The processing circuit may calculate the capacity of the other power bank according to the first voltage value, the first current value, and the power supply time. Moreover, the power bank apparatus in embodiments of the invention may measure the capacity of the other power bank after charging the other power bank. As such, the full capacity or the leftover capacity of the other power bank may be determined. In addition, the measured capacity value of the other power bank can be outputted to the mobile device, and a mobile application program of the mobile device can be used to display the capacity value. Alternatively, the capacity value may be displayed on the capacity display of the power bank apparatus. Accordingly, the user can clearly determine the measured capacity of the other power bank. Besides, the power bank apparatus in embodiments of the invention may also be used to measure the full capacity of the other power bank when it is new, in order to verify whether the full capacity of the other power bank matches with the labeled capacity.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A power bank apparatus for measuring capacities of other power banks, configured to measure a capacity value of at least one other power bank, the power bank apparatus comprising:
at least one input port configured to receive at least one input power signal from the at least one other power bank to serve as at least one capacity measuring signal;
at least one first detection circuit connected to the at least one input port to receive the at least one capacity measuring signal, the at least one first detection circuit detecting a voltage and a current of the at least one capacity measuring signal to generate at least one first voltage value and at least one first current value; and
a processing circuit connected to the at least one first detection circuit to receive the at least one first voltage value and the at least one first current value, the processing circuit calculating at least one power supply time according to the at least one first current value, and the processing circuit calculates the capacity value of the at least one other power bank according to the at least one first voltage value, the at least one first current value, and the at least one power supply time.

2. The power bank apparatus for measuring capacities of other power banks according to claim 1, further comprising:
a Universal Serial Bus (USB) output port connected to the processing circuit and another mobile device,
wherein, the capacity value calculated by the processing circuit is transmitted to the other mobile device through the USB output port, in order for the other mobile device to display the capacity value.

3. The power bank apparatus for measuring capacities of other power banks according to claim 1,
a charge control unit connected to the at least one input port to receive the at least one capacity measuring signal, the charge control unit controlled by the processing circuit to convert the capacity measuring signal and generate a charge signal.

4. The power bank apparatus for measuring capacities of other power banks according to claim 3, further comprising:
a battery connected to the charge control unit and receiving the charge signal, so as to be charged,
wherein the battery serves as a load of the at least one other power bank.

5. The power bank apparatus for measuring capacities of other power banks according to claim 4, further comprising:
a discharge control unit connected to the battery, the discharge control unit controlled by the processing circuit to convert a voltage of the battery and thereby generate at least one discharge signal.

6. The power bank apparatus for measuring capacities of other power banks according to claim 5, further comprising:
at least one output port connected to the discharge control unit and receiving the at least one discharge signal to serve as at least one output power signal, and providing the at least one output power signal to at least one external load.

7. The power bank apparatus for measuring capacities of other power banks according to claim 6, wherein the at least one external load is at least one mobile device.

8. The power bank apparatus for measuring capacities of other power banks according to claim 6, wherein the at least one external load is the at least one other power bank, wherein the power bank apparatus further comprises:
at least one second detection circuit connected to the discharge control unit to receive the at least one discharge signal, the at least one second detection circuit measuring a voltage and a current of the at least one discharge signal and generating at least one second voltage value and at least one second current value,
wherein the processing circuit determines whether the at least one other power bank has completed charging according to the at least one second current value,
when a determination result is yes, the processing circuit controls the discharge control unit to stop generating the at least one discharge signal, the processing circuit controlling the charge control unit to begin generating the charge signal, and the processing circuit beginning to calculate the at least one power supply time according to the at least one first current value.

9. The power bank apparatus for measuring capacities of other power banks according to claim 6, wherein the at least one output port is connected to the processing circuit,
wherein the processing circuit outputs the capacity value of the at least one other power bank to a mobile device through the at least one output port,
wherein the mobile device comprises a mobile application program configured to display the capacity value of the at least one other power bank.

10. The power bank apparatus for measuring capacities of other power banks according to claim 6, further comprising:
a capacity display connected to the processing circuit, the capacity display configured to display the capacity value of the at least one other power bank.
